(19) United States
(12) Patent Application Publication
(10) Pub. No.: US 2026/0242627 A1
(43) Pub. Date: Aug. 20, 2026

(54) Ink Jet Ink Composition And Recording Method

(71) Applicant: SEIKO EPSON CORPORATION, Tokyo (JP)

(72) Inventors: Tetsuya AOYAMA, Shiojiri (JP); Masahiro YATAKE, Omura (JP)

(21) Appl. No.: 19/544,413

(22) Filed: Feb. 19, 2026

(30) Foreign Application Priority Data
Feb. 20, 2025 (JP) 2025-026149

(51) Int. Cl. C09D 11/322; B41J 2/01

(52) U.S. Cl. CPC C09D 11/322; B41J 2/01

(57) ABSTRACT

Provided is a water-based ink jet ink composition containing a binder resin, wherein the binder resin contains an acrylic-based resin that is a block copolymer containing a structural unit derived from isobornyl (meth)acrylate, and a polyether-based urethane resin.

### CROSS REFERENCE TO RELATED APPLICATION

The present application is based on, and claims priority from JP Application Serial Number 2025-026149, filed February 20, 2025, the disclosure of which is hereby incorporated by reference herein in its entirety.

### BACKGROUND

### Technical Field

The present disclosure relates to an ink jet ink composition and a recording method.

### Related Art

Ink jet recording methods can record high-definition images using a relatively simple apparatus, and achieve rapid development in various fields. For example, JP-A-2021-187095 discloses, for the purpose of providing a white ink composition that can form a white image with excellent fillability even when a treatment liquid is used, a white ink composition that is a water-based ink jet ink containing a white pigment, wherein the white ink composition is used for recording performed by attaching a treatment liquid containing a flocculant to a recording medium, the recording medium is a low-absorbent recording medium or a non-absorbent recording medium, the white ink composition contains a dispersant for dispersing the white pigment and a fixing resin, and the dispersant is a nonionic dispersant.

Ink jet ink compositions containing a binder resin are still insufficient in abrasion resistance, adhesion, and the like.

### SUMMARY

An ink jet ink composition according to an aspect of the present disclosure is a water-based ink containing a binder resin, wherein the binder resin contains an acrylic-based resin (hereinafter also referred to as "acrylic-based resin A") that is a block copolymer containing a structural unit derived from isobornyl (meth)acrylate, and a polyether-based urethane resin (hereinafter also referred to as "urethane resin B").

A recording method according to an aspect of the present disclosure includes an attaching step of ejecting an ink containing the ink jet ink composition from an ink jet head to attach the ink to a recording medium.

### BRIEF DESCRIPTION OF THE DRAWINGS

FIG. 1 is a diagram illustrating an example of a recording apparatus used in a recording method of the present embodiment.

FIG. 2 is Table 1 showing the monomer compositions of acrylic-based resins used in Examples.

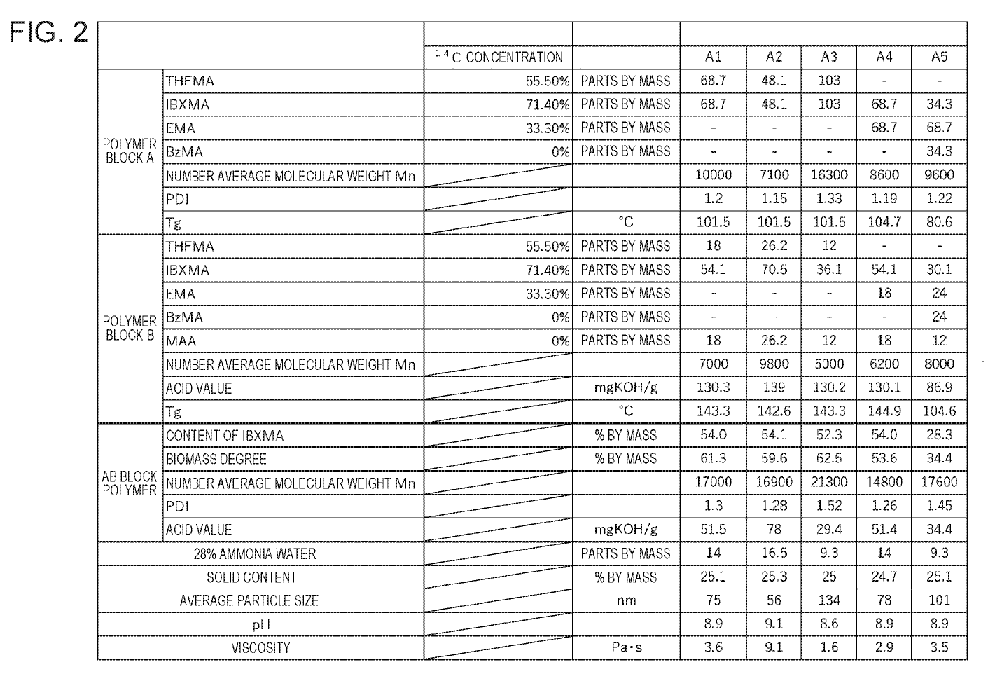

FIG. 3 is Table 2 showing the monomer compositions of urethane resins used in Examples.

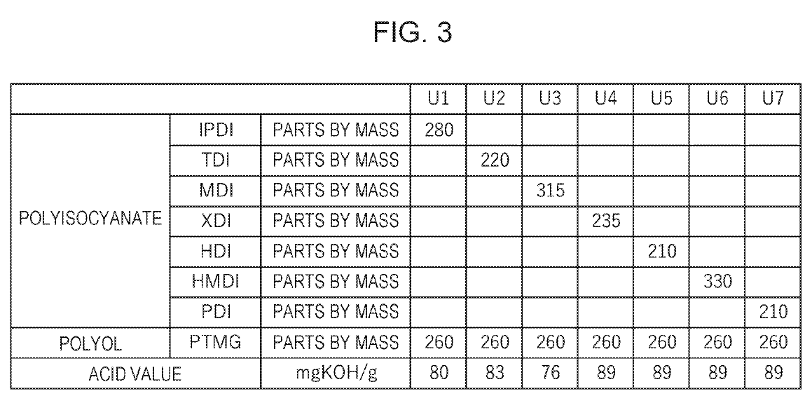

FIG. 4 is Table 3 showing the compositions of respective compositions used in Examples and the evaluation results thereof.

FIG. 5 is Table 4 showing the compositions of respective compositions used in Examples and the evaluation results thereof.

FIG. 6 is Table 5 showing the compositions of respective compositions used in Examples and Comparative Examples and the evaluation results thereof.

### DESCRIPTION OF EMBODIMENTS

The present embodiment will be described below in detail with reference to the drawings as needed, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

An ink jet ink composition according to the present embodiment is a water-based ink containing a binder resin, in which the binder resin contains an acrylic-based resin A that is a block copolymer containing a structural unit derived from isobornyl (meth)acrylate, and a polyether-based urethane resin B.

Ink jet inks are also used on various plastic films, such as biaxially oriented polypropylene (hereinafter also referred to as "OPP") and polyethylene terephthalate (hereinafter also referred to as "PET"). The biaxially oriented polypropylene is a nonpolar resin, whereas PET is a polar resin, and they have different tendencies of the adhesion, the abrasion resistance, and the like of the ink. In general, a binder resin is used in inks for the purpose of improving adhesion to a recording medium and abrasion resistance. However, when recording is performed on these plastics having different properties with the same ink, it is difficult to obtain an ink that exhibits excellent adhesion and abrasion resistance to both the plastic films.

In addition, it is difficult for the binder resin added to the ink to form a smooth film on the recording medium, and it is difficult to obtain an effect as a binder in some cases. For example, it has been considered that when an organic solvent in the ink becomes rich (the content in the ink increases) along with the drying of the ink on the recording medium, the binder resin is easily dissolved by the organic solvent in the ink, and a smooth film is formed. However, even in this case, the binder resin does not easily dissolve, and it is difficult to form a smooth film even by heating in a post-process in some cases.

Given these circumstances, in the present embodiment, as the binder resin, an acrylic-based resin that is a block copolymer containing a structural unit derived from isobornyl (meth)acrylate, and a polyether-based urethane resin are used in combination. Since isobornyl (meth)acrylate is rigid and bulky, the acrylic-based resin A is rigid and hard, and the ink has excellent dry abrasion resistance, wet abrasion resistance, ethanol resistance, and adhesion especially for a nonpolar recording medium. Since the urethane resin B has a polyether structure having high hydrophilicity, it has high affinity with portions having high hydrophilicity of the recording medium or a coloring material, and the ink has excellent adhesion, dry abrasion resistance, and wet abrasion resistance even for a recording medium having high polarity.

In addition, the urethane resin B, which is not easily dissolved even in the ink in which the organic solvent becomes rich on the recording medium by itself, is surrounded by the acrylic-based resin A, which is easily dissolved in the organic solvent and easily forms a smooth film, and thus the coating film as a whole easily becomes a smooth film. As a result, it is considered that the effects of dry abrasion resistance, wet abrasion resistance, ethanol resistance, and adhesion by the acrylic-based resin A and the urethane resin B can be obtained even for recording media having various polarities.

Components which may be included in the ink composition according to the present embodiment and a method for producing the same will be described in detail below.

### 1.1. Coloring Material

The ink composition according to the present embodiment may contain a coloring material. The coloring material is not particularly limited, and both a pigment and a dye can be used. Examples of the pigment include inorganic pigments such as carbon black and titanium white; and organic pigments. Examples of the dye include acidic dyes, direct dyes, reactive dyes, and basic dyes. Among these, the ink composition according to the present embodiment preferably contains a pigment.

Examples of the organic pigments include azo pigments such as an azo lake pigment, an insoluble monoazo pigment, an insoluble disazo pigment, a condensed azo pigment, and a chelate azo pigment; polycyclic pigments such as a phthalocyanine pigment, a quinacridone pigment, a perylene pigment, a perinone pigment, an anthraquinone pigment, a dioxazine pigment, a thioindigo pigment, an isoindolinone pigment, and a quinophthalone pigment; dye chelates such as a basic dye-type chelate and an acid dye-type chelate; and nitro pigments and nitroso pigments.

Examples of the inorganic pigments include titanium oxide, iron oxide yellow, iron oxide brown, chromium oxide, ultramarine, Prussian blue, molybdenum red, iron oxide black, lead yellow, composite oxide pigments, and carbon black.

Examples of the carbon black used as a black pigment include C.I. (Colour Index Generic Name) Pigment Black 1, 7, and 11. Examples of commercially available products of the carbon black include No. 2300, No. 900, MCF88, No. 33, No. 40, No. 45, No. 52, MA7, MA8, MA100, and No. 2200B (trade names, manufactured by Mitsubishi Chemical Corporation), Raven 5750, 5250, 5000, 3500, 1255, and 700 (trade names, manufactured by Columbia Carbon Inc.), Regal 400R, 330R, 660R, Mogul L, Monarch 700, 800, 880, 900, 1000, 1100, 1300, and 1400 (trade names, manufactured by Cabot Corporation), and Color Black FW1, FW2, FW2V, FW18, FW200, S150, S160, S170, Printex 35, U, V, 140U, Special Black 6, 5, 4A, and 4 (trade names, manufactured by Degussa Corporation). The carbon black may be produced by a known method such as a contact method, a furnace method, or a thermal method.

Examples of a white pigment include C.I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat blue 4 and 60.

Examples of pigments other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Specific examples of the dye include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The content of the pigment is preferably 0.1% by mass or more and 10% by mass or less, 2% by mass or more and 6% by mass or less, or 3% by mass or more and 5% by mass or less with respect to the total amount of the ink composition. When the content of the pigment is within the above range, the blocking resistance, the dry abrasion resistance, the wet abrasion resistance, the adhesion, the clogging recoverability, and the intermittent printing stability tend to be further improved.

The content of the coloring material is preferably 0.1% by mass or more and 10% by mass or less, 2% by mass or more and 6% by mass or less, or 3% by mass or more and 5% by mass or less with respect to the total amount of the ink composition. When the content of the coloring material is within the above range, the blocking resistance, the dry abrasion resistance, the wet abrasion resistance, the adhesion, clogging recoverability, and the intermittent printing stability tend to be further improved.

### 1.2. Binder Resin

The ink composition according to the present embodiment contains an acrylic-based resin A that is a block copolymer containing a structural unit derived from isobornyl (meth)acrylate, and a polyether-based urethane resin B. When containing the acrylic-based resin A and the urethane resin B, the ink composition has excellent blocking resistance, dry abrasion resistance, wet abrasion resistance, ethanol resistance, and adhesion for recording media having various polarities.

### 1.2.1. Acrylic-Based Resin A

The acrylic-based resin A is a block copolymer containing a structural unit derived from isobornyl (meth)acrylate, and is preferably a self-emulsifying type resin. The acrylic-based resin is a resin containing at least an acrylic-based monomer as a structural component. The acrylic-based monomer is a monomer having a (meth)acryloyl group such as (meth)acrylic acid, (meth)acrylate, or (meth)acrylamide. A copolymer of the acrylic-based monomer and another monomer may be used.

The self-emulsifying type resin is a resin that can be stabilized as a resin emulsion by itself without using any emulsifier in a water-based composition. The acrylic-based resin A, which is a self-emulsifying type resin, dissolves in the ink when the drying of the ink progresses and the organic solvent becomes rich, and can be self-emulsified (redispersed) again when the concentration of water increases again. Since dissolution and dispersion of the resin are reversible, the ink has excellent redispersibility, and has excellent clogging recoverability and intermittent printing stability. In addition, when drying of the ink progresses and the organic solvent becomes rich on the recording medium, the acrylic-based resin A dissolves and diffuses in the solvent, easily forms a smooth film on the recording medium, and has excellent dry abrasion resistance, wet abrasion resistance, and adhesion especially on a nonpolar recording medium.

The block copolymer is not particularly limited. For example, the block copolymer may be a diblock copolymer, may be a triblock copolymer, or may have more blocks. The diblock copolymer is preferred.

Furthermore, the block may contain a single monomer, or may contain two or more kinds of monomers. In the block containing two or more kinds of monomers, the two or more kinds of monomers may be randomly arranged.

The content of the structural unit derived from isobornyl (meth)acrylate in the acrylic-based resin A is preferably 10 to 80% by mass, 25 to 70% by mass, 40 to 65% by mass, 45 to 60% by mass, or 50 to 55% by mass with respect to the total amount of the acrylic-based resin A. When the content of the structural unit derived from isobornyl (meth)acrylate is within the above range, the blocking resistance, the dry abrasion resistance, the wet abrasion resistance, the ethanol resistance, and the adhesion tend to be further improved.

The total content of the structural unit derived from isobornyl (meth)acrylate and other acrylic-based monomers is preferably 50% by mass or more, 80% by mass or more, 90% by mass or more, 95% by mass or more, 99% by mass or more, or 99.9% by mass or more with respect to the total amount of the acrylic-based resin A. The total content may be 100% by mass.

When the total content of the structural unit derived from the acrylic-based monomer is within the above range, the blocking resistance, the dry abrasion resistance, the wet abrasion resistance, the ethanol resistance, and the adhesion tend to be further improved. Note that the acrylic-based monomer according to the present embodiment contains (meth)acrylic acid, (meth)acrylate, or (meth)acrylamide in the molecule.

Note that the acrylic-based resin A may contain the acrylic-based monomer and a monomer other than the acrylic-based monomer, and examples of the monomer other than the acrylic-based monomer include a vinyl-based monomer. However, when the vinyl-based monomer is contained, the solubility of the resin when the drying of the ink progresses and the organic solvent becomes rich tends to be low. On the other hand, when the vinyl-based monomer is contained, the hydrophobicity of the resin tends to further increase. However, in the acrylic-based resin A of the present embodiment, the hydrophobicity of the A block is easily expressed by concentrating a structure having high hydrophobicity in the A block, and thus the hydrophobicity of the A block can be increased even when the vinyl-based monomer is not contained.

The monomer constituting the acrylic-based resin A is not particularly limited, and, for example, a hydrophobic monomer and a hydrophilic monomer can be used. The hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl (meth)acrylate, cyclohexyl (meth)acrylate, 2-ethylhexyl (meth)acrylate, octyl (meth)acrylate, decyl (meth)acrylate, lauryl (meth)acrylate, stearyl (meth)acrylate, isopropyl (meth)acrylate, isobutyl (meth)acrylate, tert-butyl (meth)acrylate, isoamyl (meth)acrylate, isooctyl (meth)acrylate, isodecyl (meth)acrylate, isododecyl (meth)acrylate, isostearyl (meth)acrylate, and dicyclopentanyl (meth)acrylate; and aromatic group-containing monomers such as styrene, α-methylstyrene, 2-methylstyrene, vinyltoluene, divinylbenzene, chlorostyrene, phenyl (meth)acrylate, benzyl (meth)acrylate, and phenoxyethyl (meth)acrylate. Isobornyl (meth)acrylate also belongs to the hydrophobic monomer.

The hydrophilic monomer is not particularly limited, and examples thereof include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate; ether-containing monomers such as cyclic trimethylolpropane formal (meth)acrylate, tetrahydrofurfuryl (meth)acrylate, and (2-methyl-2-ethyl-1,3-dioxolan-4-yl)methyl acrylate; unsaturated tertiary amine-containing monomers such as N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, N,N-dimethylallylamine, vinylpyrrolidone, 2-vinylpyridine, 4-vinylpyridine, 2-methyl-6-vinylpyridine, and 5-ethyl-2-vinylpyridine; and ionic monomers such as unsaturated ammonium salt-containing monomers such as quaternized N,N-dimethylaminoethyl (meth)acrylate, quaternized N,N-diethylaminoethyl (meth)acrylate, and quaternized N,N-dimethylaminopropyl (meth)acrylate.

The method for obtaining the block copolymer is not particularly limited, and examples thereof include free radical polymerization and living radical polymerization. Among these, to obtain a fine block copolymer structure, living radical polymerization is preferably used. The living radical polymerization is not particularly limited, and examples thereof include the NMP method using a nitroxide or the like, the ATRP method using redox of a metal complex, the RAFT method using dithiocarboxylate or the like, a method using a cobalt catalyst, the TERP method using a tellurium compound; iodine transfer polymerization using iodine, and the RTCP method in which an iodide is used as an initiator and an organic compound is used as a catalyst.

The initiator is not particularly limited so long as it is a known initiator used for radical polymerization, and examples thereof include azo compounds such as azobis(isobutyronitrile) and 2,2'-azobis(4-methoxy-2,4-dimethylvaleronitrile); and peroxides such as benzoyl peroxide and dicumyl peroxide.

The acrylic-based resin A preferably contains a block polymer containing an A block and a B block having a higher acid value than the A block. Examples of such an AB block polymer include a polymer having the A block having high hydrophobicity and the B block having higher hydrophilicity than the A block.

In particular, an AB block copolymer having one A block and one B block in one molecular chain is preferred.

In such an acrylic-based resin A, since the hydrophobic structure is concentrated in the A block and the hydrophilic structure is concentrated in the B block, a micelle structure in which the hydrophobic block is directed to the central portion and the hydrophilic block is directed to the outer side is easily formed, and the acrylic-based resin A is easily self-dispersed in the ink.

In addition, when the drying of the ink progresses and the organic solvent becomes rich due to the action of the A block in which the hydrophobic structure is concentrated, the acrylic-based resin A easily dissolves and dissolves in the ink. Thus, reversible dispersion and dissolution are possible.

The acrylic-based resin A is preferably dissolved in an organic solvent with the composition of the organic solvent contained in the ink.

Thus, the clogging recoverability and the intermittent printing stability tend to be further improved. In addition, since the resin has a concentrated hydrophobic portion, the resin has excellent solubility in the organic solvent, and thus a smooth film is more easily formed, and the blocking resistance, the dry abrasion resistance, the wet abrasion resistance, the ethanol resistance, and the adhesion tend to be further improved.

The monomer constituting the B block contains a monomer having an acidic group, and may contain a monomer having no acidic group as needed. The monomer constituting the A block contains a monomer having no acidic group, and may contain a monomer having an acidic group within a range not exceeding the acid value of the B block.

Examples of the monomer having an acidic group include, among the hydrophilic monomers described above, unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; and unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate.

The monomer having no acidic group is not particularly limited, and examples thereof include other monomers such as a hydrophobic monomer.

The content of the monomer having an acidic group in the B block is preferably 1 to 50% by mass, 5 to 40% by mass, 10 to 30% by mass, or 15 to 25% by mass with respect to the total amount of the monomers of the B block. When the content of the monomer having an acidic group in the B block is within the above range, the abrasion resistance, the clogging recoverability, and the redispersibility tend to be further improved.

In the present embodiment, the block polymer containing the A block and the B block having a higher acid value than the A block is preferably a copolymer containing an A block having two or more kinds of hydrophobic monomers and a B block having one or more kinds of hydrophobic monomers and hydrophilic monomers each. The hydrophobic monomers contained in the A block and the B block may be the same.

Note that the acid value in the present embodiment can be determined by calculation from the ratio of the monomer having an acidic group among the monomers of the block, and can also be measured by the method shown in Examples.

The acid value of the acrylic-based resin A is preferably 25 to 100 mgKOH/g, 30 to 70 mgKOH/g, or 40 to 60 mgKOH/g. When the acid value of the acrylic-based resin A is within the above range, the blocking resistance, the dry abrasion resistance, the wet abrasion resistance, the ethanol resistance, and the adhesion tend to be further improved.

The acid value of the B block is preferably 50 to 200 mgKOH/g, 80 to 150 mgKOH/g, or 100 to 140 mgKOH/g.

The acid value of the A block may be 0 mgKOH/g or more than 0 mgKOH/g, but since it is lower than the acid value of the B block, it is preferably 30 mgKOH/g or less, 20 mgKOH/g or less, 10 mgKOH/g or less, 5 mgKOH/g or less, or 3 mgKOH/g or less.

The number average molecular weight of the acrylic-based resin A is preferably 10,000 to 25,000, 14,000 to 22,000, 15,000 to 21,000, 16,000 to 20,000, or 16,500 to 18,000. When the number average molecular weight is within the above range, the blocking resistance, the dry abrasion resistance, the wet abrasion resistance, the ethanol resistance, and the adhesion tend to be further improved.

The polydispersity index (PDI) of the acrylic-based resin A is preferably 1 to 5, 1.1 to 2, 1.2 to 1.6, or 1.27 to 1.5. When the polydispersity index is within the above range, the blocking resistance, the dry abrasion resistance, the wet abrasion resistance, the ethanol resistance, and the adhesion tend to be further improved.

The biomass degree of the acrylic-based resin A is preferably 30 to 100% by mass, 40 to 70% by mass, or 50 to 65% by mass. When the biomass degree is within the above range, the blocking resistance, the dry abrasion resistance, the wet abrasion resistance, the ethanol resistance, and the adhesion tend to be further improved while the ink is made more environmentally friendly. The biomass degree is a dry mass ratio of the biomass raw material used. The biomass raw material refers to organic resources produced from animals and plants, excluding fossil resources. In the present embodiment, examples of the biomass raw material include monomers produced from raw materials derived from animals and plants.

The biomass degree of a compound can be measured by a known method based on the concentration of ¹⁴C measured by accelerator mass spectrometry (AMS).

The average particle size of the acrylic-based resin A is preferably 30 to 200 nm, 50 to 140 nm, 60 to 130 nm, 65 to 110 nm, or 70 to 90 nm. When the average particle size of the acrylic-based resin A is within the above range, the blocking resistance, the dry abrasion resistance, the wet abrasion resistance, the ethanol resistance, and the adhesion tend to be further improved.

The glass transition point of the acrylic-based resin A is preferably 50 to 150°C, 80 to 140°C, or 100 to 120°C. In this case, the blocking resistance, the dry abrasion resistance, the wet abrasion resistance, the ethanol resistance, the adhesion, and the like tend to be further improved.

The glass transition point can be measured by DSC.

The content of the acrylic-based resin A is preferably 0.1 to 10% by mass, 0.5 to 5% by mass, or 1 to 3% by mass with respect to the total amount of the ink composition. When the acid value of the acrylic-based resin A is within the above range, the blocking resistance, the dry abrasion resistance, the wet abrasion resistance, the ethanol resistance, and the adhesion tend to be further improved.

### 1.2.2. Urethane Resin B

The urethane resin B is a urethane resin containing a polyether skeleton. Since the urethane resin B has a polyether structure having high hydrophilicity, it has high affinity with portions having high hydrophilicity of the recording medium or the coloring material, and thus the ink has excellent adhesion, dry abrasion resistance, and wet abrasion resistance for a recording medium having high polarity.

On the other hand, since the urethane resin B has the polyether structure having high hydrophilicity, even when the organic solvent in the ink becomes rich along with the drying of the ink, the urethane resin B is difficult to dissolve, and it tends to be difficult to form a smooth film even by heating in a post-process. However, when the acrylic-based resin A and the urethane resin B described above are used in combination in the ink of the present embodiment, the ink has excellent adhesion, dry abrasion resistance, and wet abrasion resistance.

It is presumed that since the acrylic-based resin A easily dissolves, it easily wraps the urethane resin B to form a smooth film, and since both the B block of the acrylic-based resin A and the urethane resin B have high hydrophilicity and high affinity, a tough coating film is formed.

When the urethane resin is not a urethane resin containing a polyether skeleton but a urethane resin containing a polyester skeleton, it is presumed that a tough coating film cannot be formed because the urethane resin does not have a highly hydrophilic polyether skeleton having a high affinity for the B block of the acrylic-based resin A. In addition, the wet abrasion resistance and the ethanol resistance are not excellent.

The urethane resin is a general term for resins having a urethane skeleton, and refers to a resin containing a urethane bond, a urea bond, or an allophanate bond formed by the reaction of an isocyanate group with an active hydrogen-containing group such as a hydroxy group, an amino group, a urethane bond group, or a carboxy group. The urethane resin B is polymerized using, for example, a polyisocyanate and a polyol containing a polyether skeleton.

The urethane resin B may be a self-emulsifying type resin, which is stabilized as a resin emulsion by itself without using any emulsifier, or an emulsifier type resin, which is stabilized as a resin emulsion by using an emulsifier.

When the urethane resin B is of the self-emulsifying type, it may not be able to be reversibly dissolved and redispersed like the acrylic-based resin A. Even when such a urethane resin B is used, it can be dissolved in a solvent by the acrylic-based resin A surrounding the urethane resin B, and a smooth film is easily formed as the entire coating film. Therefore, by using the urethane resin B and the acrylic-based resin A in combination, the ink has excellent blocking resistance, dry abrasion resistance, wet abrasion resistance, ethanol resistance, and adhesion.

The urethane resin B preferably has an aromatic ring skeleton and/or an alicyclic skeleton. Such a urethane resin B tends to further improve in the dry abrasion resistance, the wet abrasion resistance, and the ethanol resistance. The aromatic ring skeleton and the alicyclic skeleton may be derived from a diisocyanate, derived from a polyol, or derived from another monomer. It is preferably derived from a diisocyanate.

When the urethane resin B has an aromatic ring skeleton, the abrasion resistance, the ethanol resistance, and the like are particularly excellent, which is preferable.

The acid value of the urethane resin B is preferably 40 to 130 mgKOH/g, 50 to 120 mgKOH/g, 60 to 100 mgKOH/g, 70 to 90 mgKOH/g, or 78 to 84 mgKOH/g. When the acid value of the urethane resin B is within the above range, the blocking resistance, the dry abrasion resistance, the wet abrasion resistance, the ethanol resistance, and the adhesion tend to be further improved.

The mass ratio of the urethane resin B to the acrylic-based resin A is preferably 1/3 to 3, 0.5 to 2, 2/3 to 1.5, or 0.8 to 1.2. When the mass ratio of the urethane resin B to the acrylic-based resin A is within the above range, the storage stability, the color developability, the transfer resistance, the abrasion resistance, and the bubble dischargeability tend to be further improved.

The content of the urethane resin B is preferably 0.1 to 10% by mass, 0.5 to 5% by mass, or 1 to 3% by mass with respect to the total amount of the ink composition. When the content of the urethane resin B is within the above range, the blocking resistance, the dry abrasion resistance, the wet abrasion resistance, the ethanol resistance, and the adhesion tend to be further improved.

The total content of the acrylic-based resin A and the urethane resin B is preferably 0.5 to 20% by mass, 1 to 10% by mass, or 2 to 5% by mass with respect to the total amount of the ink composition. When the total content is within the above range, the blocking resistance, the dry abrasion resistance, the wet abrasion resistance, the ethanol resistance, and the adhesion tend to be further improved.

### 1.2.2.1 Polyisocyanate

The polyisocyanate means a compound having two or more isocyanate groups in the molecular structure, and is not particularly limited, and examples thereof include an aliphatic polyisocyanate and an aromatic polyisocyanate.

The aliphatic polyisocyanate is not particularly limited, and examples thereof include polyisocyanates having a chain structure such as tetramethylene diisocyanate, dodecamethylene diisocyanate, 1,5-pentamethylene diisocyanate, 1,6-hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate; and polyisocyanates having a cyclic structure such as isophorone diisocyanate, hydrogenated xylylene diisocyanate, 4,4'-methylenebis(cyclohexyl isocyanate), 1,4-cyclohexane diisocyanate, methylcyclohexane diisocyanate, isophorone diisocyanate, and 1,3-bis(isocyanatomethyl)cyclohexane.

The aromatic polyisocyanate is not particularly limited, and examples thereof include tolylene diisocyanate, 2,2'-diphenylmethane diisocyanate, 2,4'-diphenylmethane diisocyanate, 4,4'-diphenylmethane diisocyanate, 4,4'-dibenzyl diisocyanate, 1,5-naphthylene diisocyanate, xylylene diisocyanate, 1,3-phenylene diisocyanate, 1,4-phenylene diisocyanate, 2,4 toluene diisocyanate, m-xylene diisocyanate, dialkyldiphenylmethane diisocyanate, tetraalkyldiphenylmethane diisocyanate, and α,α,α',α'-tetramethylxylylene diisocyanate.

### 1.2.2.2. Polyol

The polyol is a compound having two or more hydroxy groups in its molecular structure. The polyol of the present embodiment is not particularly limited, and examples thereof include a low molecular weight polyol, a polyether polyol, a polyester polyol, and a polycarbonate polyol.

Examples of the low molecular weight polyol include diols such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihydroxyphenylpropane, 4,4-dihydroxyphenylmethane, hydrogenated bisphenol A, dimethylolurea and derivatives thereof; and triols such as glycerin, trimethylolpropane, 1,2,5-hexanetriol, 1,2,6-hexanetriol, pentaerythritol, and trimethylol melamine and derivatives thereof.

The polyether polyol is not particularly limited, and examples thereof include addition polymers of alkylene oxides and polyols, polyalkylene glycols, and alkylene glycol copolymers.

The alkylene oxide is not particularly limited, and examples thereof include ethylene oxide, propylene oxide, butylene oxide, and α-olefin oxide. Examples of the polyol to be addition-polymerized with the alkylene oxide include those exemplified as the above low molecular weight polyol.

Examples of the polyalkylene glycol include polyethylene glycol, polypropylene glycol, and polytetramethylene ether glycol. Examples of the alkylene glycol copolymer include ethylene glycol-propylene glycol copolymers.

The polyester polyol is not particularly limited, and examples thereof include acid esters. The acid component constituting the acidic ester is not particularly limited so long as it has two or more acidic groups, and examples thereof include aromatic dicarboxylic acids such as phthalic acid, naphthalenedicarboxylic acid, biphenyldicarboxylic acid, and tetrahydrophthalic acid; alicyclic dicarboxylic acids such as hydrogenated products of these aromatic dicarboxylic acids; and aliphatic dicarboxylic acids such as malonic acid, succinic acid, tartaric acid, oxalic acid, glutaric acid, adipic acid, pimelic acid, suberic acid, azelaic acid, sebacic acid, alkylsuccinic acid, linoleic acid, maleic acid, fumaric acid, mesaconic acid, citraconic acid, and itaconic acid. Anhydrides, salts, derivatives (alkyl esters, acid halides) and the like of these can also be used as the acid component. The component forming an ester with the acid component is not particularly limited so long as it has two or more hydroxy groups, and examples thereof include polyols such as diols and triols; and glycols such as (poly)alkylene glycols. Examples of the polyols and glycols include those exemplified as the above low molecular weight polyol.

The polycarbonate polyol is not particularly limited, and examples thereof include alkanediol-based polycarbonate diols such as polyhexamethylene carbonate diol. Further examples include a polycarbonate diol obtained by reacting a carbonate component such as an alkylene carbonate, a diaryl carbonate, or a dialkyl carbonate, or phosgene with an aliphatic diol component.

### 1.3. Wax Emulsion

The ink composition according to the present embodiment preferably contains a wax emulsion. When the wax emulsion is contained, the blocking resistance, the dry abrasion resistance, the wet abrasion resistance, the ethanol resistance, and the adhesion of recorded matter tend to be further improved. In the present specification, "wax emulsion" mainly means a dispersion of solid wax particles in water using a surfactant.

Examples of the wax include animal waxes, vegetable waxes, and petroleum waxes. Examples of the animal waxes include lanolin and beeswax. Examples of the vegetable waxes include avocado oil, linseed oil, almond oil, fennel oil, perilla oil, olive oil, orange oil, orange roughy oil, cocoa butter, chamomile oil, carrot oil, cucumber oil, apricot kernel oil, kukui nut oil, walnut oil, wheat germ oil, sesame oil, rice oil, rice bran oil, sasanqua oil, safflower oil, salad oil, shea butter, soybean oil, tea oil, evening primrose oil, camellia oil, corn oil, rapeseed oil, persic oil, safflower oil, castor oil, sunflower oil, grape seed oil, hazelnut oil, macadamia nut oil, cottonseed oil, meadowfoam oil, peanut oil, rosehip oil, turtle oil, cocoa butter, palm oil, palm kernel oil, Japan wax, carnauba wax, coconut oil, and waxes produced from hydrogenated products of these oils and fats and derivatives thereof.

Examples of the petroleum waxes include polyolefin waxes such as polyethylene waxes and polypropylene waxes, polyoxyalkylene alkyl ether waxes, paraffin waxes, microcrystalline waxes, and petrolatum. In the present specification, "paraffin wax" means a mixture of hydrocarbons having a weight average molecular weight of about 300 to 500, which contains a linear paraffin-based hydrocarbon (normal paraffin) having about 20 to 30 carbon atoms as a main component and a small amount of iso paraffin.

The content of the wax emulsion is preferably 0.1 to 5% by mass, 0.3 to 3% by mass, 0.5 to 2% by mass, or 0.7 to 1.5% by mass with respect to the total amount of the ink. When the content of the wax emulsion is within the above range, the blocking resistance, the dry abrasion resistance, the wet abrasion resistance, the ethanol resistance, and the adhesion tend to be further improved.

### 1.4. Silicone Acrylic Resin

The ink composition according to the present embodiment preferably further contains a silicone acrylic resin. When the silicone acrylic resin is contained, the dry abrasion resistance, the wet abrasion resistance, and the blocking resistance tend to be further improved.

Examples of the silicone acrylic resin include (graft) copolymers of (meth)acrylic monomers and dialkylsiloxane monomers, acrylic-silicone copolymers, acrylic-modified organopolysiloxanes, acrylic acid-silicone copolymers, silicone-modified (meth)acrylic polymers, and polyorganosiloxanes obtained by graft copolymerization of (meth)acrylates. As the silicone acrylic resin, a commercially available product may be used, and examples of the commercially available product include Chaline LC190 (trade name, manufactured by Nissin Chemical Co., Ltd.).

The content of the silicone acrylic resin is preferably 0.1 to 5% by mass, 0.3 to 3% by mass, 0.5 to 2% by mass, or 0.7 to 1.5% by mass with respect to the total amount of the ink. When the content of the silicone acrylic resin is within the above range, the blocking resistance, the dry abrasion resistance, the wet abrasion resistance, the ethanol resistance, and the adhesion tend to be further improved.

### 1.5. Organic Solvent

The ink composition according to the present embodiment may contain an organic solvent. In particular, an organic solvent A with an octanol-water partition coefficient (a logP_{ow} value) of 0 to 1 is preferably contained. When the ink composition contains the organic solvent A, when the drying of the ink progresses and the content of the organic component becomes predominant, the binder resin more easily dissolves in the ink, and the clogging recoverability tends to be more easily improved. In addition, since a smooth film is easily formed on a recording medium, the blocking resistance, the dry abrasion resistance, the wet abrasion resistance, the ethanol resistance, and the adhesion tend to be further improved. The ink composition according to the present embodiment may contain an organic solvent B with a logP_{ow} value other than 0 to 1 as needed.

The logP_{ow} value of the organic solvent A is preferably 0.1 to 1, 0.2 to 0.9, 0.3 to 0.8, 0.4 to 0.7, or 0.5 to 0.6. When the logP_{ow} value is 0 or more, the solubility of the binder resin becomes higher, and when the logP_{ow} value is 1 or less, the compatibility with water tends to be more excellent. Therefore, when the logP_{ow} value is within the above range, the blocking resistance, the dry abrasion resistance, the wet abrasion resistance, the ethanol resistance, the adhesion, and the clogging recoverability of the ink composition tend to be further improved.

In the present embodiment, the octanol-water partition coefficient logP_{ow} value refers to a value defined by OECD Test Guideline 107. The octanol-water partition coefficient is expressed as logP_{ow}, logK_{ow}, or the like. A higher logP_{ow} value indicates higher hydrophobicity, and a lower logP_{ow} value indicates higher hydrophilicity.

The logP_{ow} value of a compound can be determined by various methods, and, for example, it can be determined by measurement in accordance with the measurement method specified in JIS Z 7260-117. It can also be calculated using Hansen Solubility Parameter Software (HSPIP).

The ink composition of the present embodiment may also contain the organic solvents B with a logP_{ow} value of less than 0.

The organic solvents A and B are not particularly limited, and examples thereof include monoalcohols, glycols, ethers, polyols having three or more hydroxy groups, ketones, and lactam compounds. One kind of the organic solvent may be used alone, or two or more kinds thereof may be used in combination.

Examples of the monoalcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxyethanol, benzyl alcohol, and phenoxypropanol.

Examples of the glycols include alkanediols and condensates having a structure in which hydroxy groups between molecules of alkanediols are condensed. The alkanediols are alkanes substituted with two hydroxy groups. Examples of the condensates having a structure in which hydroxy groups between molecules of alkanediols are condensed include condensates having a structure in which hydroxy groups between molecules of diols of alkanes having 2 to 4 carbon atoms are condensed.

Examples of the glycols include alkanediols such as ethylene glycol, propylene glycol, 1,2-propanediol, 1,2-butanediol, 1,4-butanediol, 1,2-pentanediol, 1,2-hexanediol, 1,2-octanediol, 1,3-propanediol, 1,4-butanediol, and 1,6-hexanediol; and condensates having a structure in which hydroxy groups between molecules of alkanediols such as tetramethylene glycol, hexamethylene glycol, diethylene glycol, triethylene glycol, tetraethylene glycol, polyethylene glycol, dipropylene glycol, tripropylene glycol, polypropylene glycol, and (poly)tetramethylene glycol are condensed.

The ethers are not particularly limited, and examples thereof include alkyl ethers and glycol ethers. Examples of the alkyl ethers include dimethyl ether, methyl ethyl ether, diethyl ether, isopropyl methyl ether, and isopropyl ethyl ether.

Examples of the glycol ethers include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the polyols having three or more hydroxy groups include glycerin. Examples of the ketones include acetone, methyl ethyl ketone, and diethyl ketone. Examples of the lactam compounds include 2-pyrrolidone, N-methyl-2-pyrrolidone, N-ethyl-2-pyrrolidone, and N-hydroxyethylpyrrolidone (HEP).

Among the above organic solvents, the organic solvent A has an octanol-water partition coefficient logP_{ow} value of 0 to 1. Examples of such organic solvents A include isopropyl methyl ether, diethylene glycol monobutyl ether, triethylene glycol monobutyl ether, 1,2-hexanediol, methyl ethyl ketone; isopropyl alcohol, and methyl ethyl ketone.

The content of the organic solvent A is preferably 0.5 to 15% by mass, 3 to 12% by mass, 5 to 10% by mass, or 7 to 9% by mass with respect to the total amount of the ink composition. When the content of the organic solvent A is within the above range, the blocking resistance, the dry abrasion resistance, the wet abrasion resistance, the ethanol resistance, the adhesion, and the clogging recoverability tend to be further improved.

The content of the organic solvent B is preferably 1 to 20% by mass, 5 to 15% by mass, 7 to 14% by mass, 9 to 13% by mass, or 10 to 12% by mass with respect to the total amount of the ink composition. When the content of the organic solvent B is within the above range, the blocking resistance, the dry abrasion resistance, the wet abrasion resistance, the ethanol resistance, the adhesion, and the clogging recoverability tend to be further improved.

The total content of the organic solvent including the organic solvents A and B in the case of being included is preferably 0.5 to 30% by mass, 10 to 27% by mass, 15 to 25% by mass, 16 to 22% by mass, or 17 to 21% by mass with respect to the total amount of the ink composition. When the content of the organic solvent is within the above range, the blocking resistance, the dry abrasion resistance, the wet abrasion resistance, the ethanol resistance, the adhesion, and the clogging recoverability tend to be further improved.

### 1.6. Surfactant

The ink composition according to the present embodiment may contain a surfactant. The surfactant is not particularly limited, and examples thereof include a silicone-based surfactant, an acetylene glycol-based surfactant, and a fluorine-based surfactant.

The acetylene glycol-based surfactant is not particularly limited, and examples thereof include 2,4,7,9-tetramethyl-5-decyne-4,7-diol and an alkylene oxide adduct of 2,4,7,9-tetramethyl-5-decyne-4,7-diol. Examples of commercially available products of the acetylene glycol-based surfactant include Olfine E1010 and EXP4200, and Surfynol SE, Surfynol 440, Surfynol 104, Surfynol 465, and Surfynol DF110D (trade names, manufactured by Nissin Chemical Co., Ltd.).

The fluorine-based surfactant is not particularly limited, and examples thereof include perfluoroalkyl sulfonates, perfluoroalkyl carboxylates, perfluoroalkyl phosphates, perfluoroalkyl ethylene oxide adducts, perfluoroalkyl betaines, and perfluoroalkylamine oxide compounds.

The silicone-based surfactant is not particularly limited, and examples thereof include polysiloxane-based compounds and polyether modified organosiloxanes. Examples of commercially available products of the silicone-based surfactant include BYK-306, BYK-307, BYK-333, BYK-341, BYK-345, BYK-346, BYK-348, BYK-349, BYK-UV3500, BYK-UV3510, BYK-UV3530, and BYK-UV3570 (trade names, manufactured by BYK).

The content of the surfactant is preferably 0.1 to 3% by mass, 0.3 to 2% by mass, 0.4 to 1.5% by mass, or 0.5 to 1.0% by mass with respect to the total amount of the ink composition. When the content of the surfactant is within the above range, the adhesion, the clogging recoverability, and the intermittent printing stability tend to be further improved.

### 1.7. pH Adjuster

The ink composition according to the embodiment may contain a pH adjuster. The pH adjuster is not particularly limited, and examples thereof include inorganic acids such as sulfuric acid, hydrochloric acid, and nitric acid; inorganic bases such as lithium hydroxide, sodium hydroxide, potassium hydroxide, and ammonia; organic acids such as adipic acid, citric acid, and succinic acid; and organic bases such as triethanolamine, diethanolamine, monoethanolamine, triisopropanolamine, diisopropanolamine, and trishydroxymethylaminomethane. One kind of the pH adjuster may be used alone, or two or more kinds thereof may be used in combination.

The content of the pH adjuster is preferably 0.01 to 3% by mass, 0.05 to 1% by mass, or 0.1 to 0.5% by mass with respect to the total amount of the ink composition. When the content of the pH adjuster is within the above range, the ethanol resistance, the adhesion, the clogging recoverability, and the intermittent printing stability tend to be further improved.

### 1.8. Chelating Agent

The ink composition according to this embodiment may contain a chelating agent. The chelating agent can remove predetermined ions in the ink jet ink composition.

The chelating agent is not particularly limited, and examples thereof include ethylenediaminetetraacetic acid and salts thereof such as EDTA, disodium dihydrogen ethylenediaminetetraacetate (EDTA-2Na), trisodium monohydrogen ethylenediaminetetraacetate (EDTA-3Na), tetrasodium ethylenediaminetetraacetate (EDTA-4Na), and tripotassium monohydrogen ethylenediaminetetraacetate (EDTA-3K); diethylenetriamine pentaacetic acid and salts thereof such as DTPA, disodium diethylenetriaminepentaacetate (DTPA-2Na) and pentasodium diethylenetriaminepentaacetate (DTPA-5Na); nitrilotriacetic acid and salts thereof such as NTA, disodium nitrilotriacetate (NTA-2Na) and trisodium nitrilotriacetate (NTA-3Na); ethylenediamine-N,N'-disuccinic acid and salts thereof; 3-hydroxy-2,2'-iminodisuccinic acid and salts thereof; L-aspartic acid-N,N'-diacetic acid and salts thereof; L-glutamic acid diacetic acid and salts thereof; N-(1-carboxylatomethyl)iminodiacetic acid and salts thereof; N-(2-hydroxyethyl)iminodiacetic acid and salts thereof; ethylenediaminetetramethylene phosphonic acid and salts thereof; ethylenediaminetetrametaphosphoric acid and salts thereof; ethylenediaminepyrophosphoric acid and salts thereof; and ethylenediaminemetaphosphoric acid and salts thereof.

The content of the chelating agent is preferably 0.001 to 1% by mass, 0.005 to 0.5% by mass, or 0.01 to 0.1% by mass with respect to the total amount of the ink composition. When the content of the chelating agent is within the above range, the adhesion, the clogging recoverability, and the intermittent printing stability tend to be further improved.

### 1.6. Water

The ink jet ink composition of the present embodiment is a water-based ink containing water. The water-based ink jet ink composition is an ink jet ink composition containing at least water as a main solvent component of the ink.

The content of water is preferably 40 to 99% by mass, 50 to 90% by mass, 60 to 85% by mass, 70 to 80% by mass, or 70 to 76% by mass with respect to the total amount of the ink jet ink composition. When the content of water is within the above range, the ethanol resistance, the adhesion, the clogging recoverability, and the intermittent printing stability tend to be further improved.

### 1.7. Other Components

The ink composition may contain components other than the above-described components. As the other components, various additives such as a dissolution aid, a viscosity modifier, an antioxidant, a preservative, a fungicide, and a corrosion inhibitor can be added as appropriate.

### 2. Recording Method

A recording method according to the embodiment includes an attaching step of ejecting the ink jet ink composition, using a predetermined ink jet head, from the ink jet head, and attaching the ink jet ink composition to a recording medium. The method may further include a heating step of heating the recording medium in the ink attaching step and/or after the ink attaching step.

### 3. Recording Apparatus

A recording apparatus according to the present embodiment includes the ink composition described above and an ink jet head having a nozzle that ejects the ink composition described above onto a recording medium, and preferably further includes a supply flow path that circulates the ink composition described above and is connected to the ink jet head, and a filter unit provided in the supply flow path of the ink jet head.

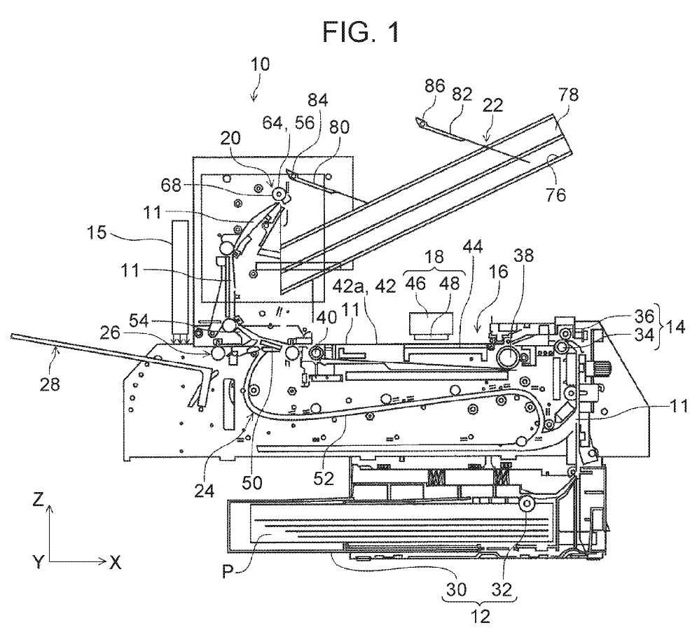

FIG. 1 illustrates an example of an ink jet recording apparatus that can be used in the present embodiment. The ink jet recording apparatus according to the present embodiment will be described in more detail with reference to FIG. 1. In the X-Y-Z coordinate system shown in FIG. 1, the X direction indicates the length direction of the recording medium, the Y direction indicates the width direction of the recording medium in a transport path in the recording apparatus, and the Z direction indicates an apparatus height direction.

A recording apparatus 10 is, for example, a line type ink jet printer capable of high-speed and high-density printing. The recording apparatus 10 includes a feeding section 12 that stores a recording medium P such as paper, a transport section 14, a belt transport section 16, a recording section 18, a face-down (Fd) discharge section 20 as "discharge section," a face-down (Fd) mounting section 22 as "mounting section," a reversing path section 24 as "reversing transport mechanism," a face-up (Fu) discharge section 26, and a face-up (Fu) mounting section 28.

The feeding section 12 is disposed at the lower portion of the apparatus in the recording apparatus 10. The feeding section 12 includes a feeding tray 30 that stores the recording medium P and a feeding roller 32 that feeds the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 that supports an upper section 42a of the endless belt 42 between the first roller 38 and the second roller 40.

The endless belt 42 is driven to move from the +X direction to the -X direction in the upper section 42a by the first roller 38 or the second roller 40 driven by a drive source (not shown). Therefore, the recording medium P transported from the transport section 14 is further transported downstream in the transport path 11 in the belt transport section 16.

The recording section 18 includes a line type ink jet head 48 and a head holder 46 that holds the ink jet head 48. Note that the recording section 18 may be a serial type recording section, in which an ink jet head is provided on a carriage that reciprocates in the Y-axis direction. The ink jet head 48 is disposed to face the upper section 42a of the endless belt 42 supported by the support 44. The ink jet head 48 ejects the ink toward the recording medium P when the recording medium P is transported in the upper section 42a of the endless belt 42, thus executing recording. The recording medium P is transported by the belt transport section 16 downstream in the transport path 11 while the recording is carried out.

A first branch section 50 is provided downstream in the transport path 11 in the belt transport section 16. The first branch section 50 is configured to be switchable between the transport path 11 for transporting the recording medium P to the Fd discharge section 20 or the Fu discharge section 26, and a reversing path 52 of the reversing path section 24 for reversing the recording surface of the recording medium P and transporting again the recording medium P to the recording section 18. The recording surface of the recording medium P, which is switched to the reversing path 52 by the first branch section 50 and is transported, is reversed in a transport process in the reversing path 52, and the recording medium P is transported again to the recording section 18 such that the surface opposite to the initial recording surface faces the ink jet head 48.

Further, a second branch section 54 is provided downstream of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and mounted on the Fd mounting section 22. At this time, the recording medium P is mounted such that the recording surface thereof faces the Fd mounting section 22. In addition, the recording medium P transported toward the Fu discharge section 26 in the second branch section 54 is discharged from the Fu discharge section 26 and mounted on the Fu mounting section 28. At this time, the recording medium P is mounted such that the recording surface thereof faces the side opposite to the Fu mounting section 28.

### 4. Recording Medium

The recording medium used in the present embodiment is not particularly limited, and examples thereof include an absorbent recording medium, a low-absorbent recording medium, and a non-absorbent recording medium.

Examples of the absorbent recording medium include plain paper such as electrophotographic paper having high ink permeability, and ink jet dedicated paper including an ink absorbing layer formed of silica particles or alumina particles or an ink absorbing layer formed of a hydrophilic polymer such as polyvinyl alcohol or polyvinyl pyrrolidone.

Examples of the low-absorbent recording medium include art paper, coated paper, and cast paper, which have relatively low ink permeability and are used for general offset printing.

Examples of the non-absorbent recording medium include films and plates of plastics such as polyvinyl chloride, polyethylene, polypropylene, biaxially oriented polypropylene (OPP), polyethylene terephthalate (PET), polycarbonate, polystyrene, and polyurethane; plates of metals such as iron, silver, copper, and aluminum; metal plates and plastic films produced by evaporation of these various metals, and plates of alloys such as stainless steel and brass; and recording media in which a film of a plastic such as polyvinyl chloride, polyethylene, polypropylene, polyethylene terephthalate (PET), polycarbonate, polystyrene, or polyurethane is bonded (applied) to a paper substrate.

Among the plastics of the non-absorbent recording medium, examples thereof include polar recording media such as PET and nonpolar recording media such as OPP. These may be different in the tendency of ink adhesion, abrasion resistance, or the like, but the ink of the present embodiment is useful because recording on these plastics having different properties can be performed with the same ink.

The ink of the present embodiment may be an ink for use in recording on polar plastics. Alternatively, the ink may be an ink for use in recording on nonpolar plastics. Further, the ink may be an ink for use in recording on polar plastics and nonpolar plastics.

In addition, in the recording method of the present embodiment, ink adhesion may be performed for recording on polar plastics. Alternatively, ink adhesion may be performed for recording on nonpolar plastics.

Further, the recording apparatus of the present embodiment may be a recording apparatus for use in recording on polar plastics and nonpolar plastics using the ink of the present embodiment.

### 5. Recorded Matter

Recorded matter of the present embodiment is obtained by attaching the ink composition described above to the recording medium. The recorded matter of the present embodiment using the ink composition described above can be recorded with an ink having excellent blocking resistance, dry abrasion resistance, wet abrasion resistance, ethanol resistance, adhesion, clogging recoverability, and intermittent printing stability.

### EXAMPLES

Hereinafter, the present disclosure will be described in more detail with reference to Examples and Comparative Examples. The present disclosure is not limited by Examples below in any way.

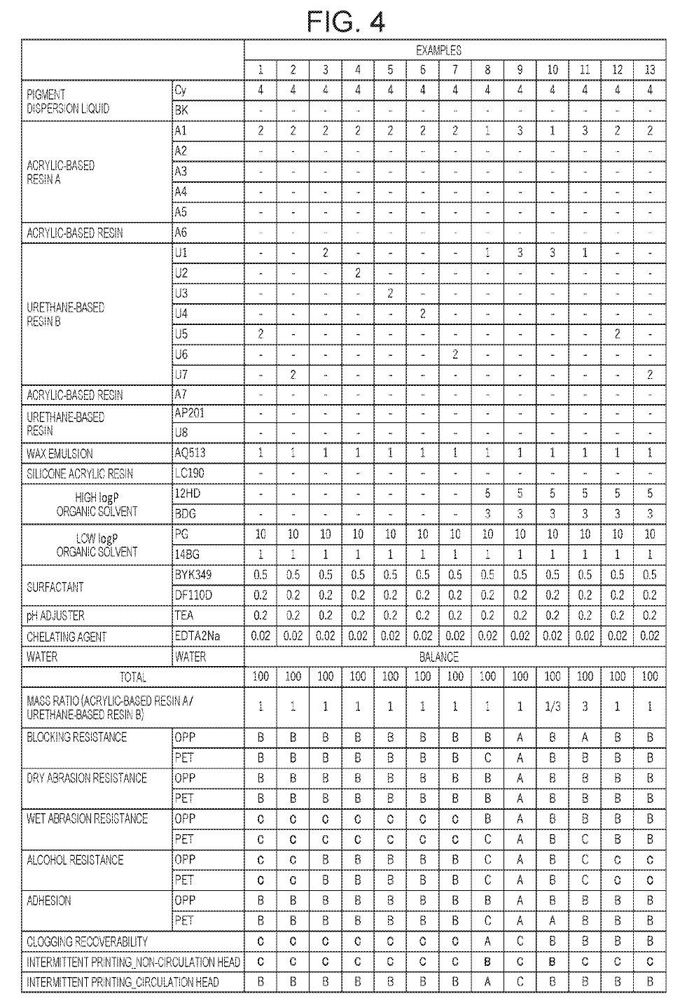

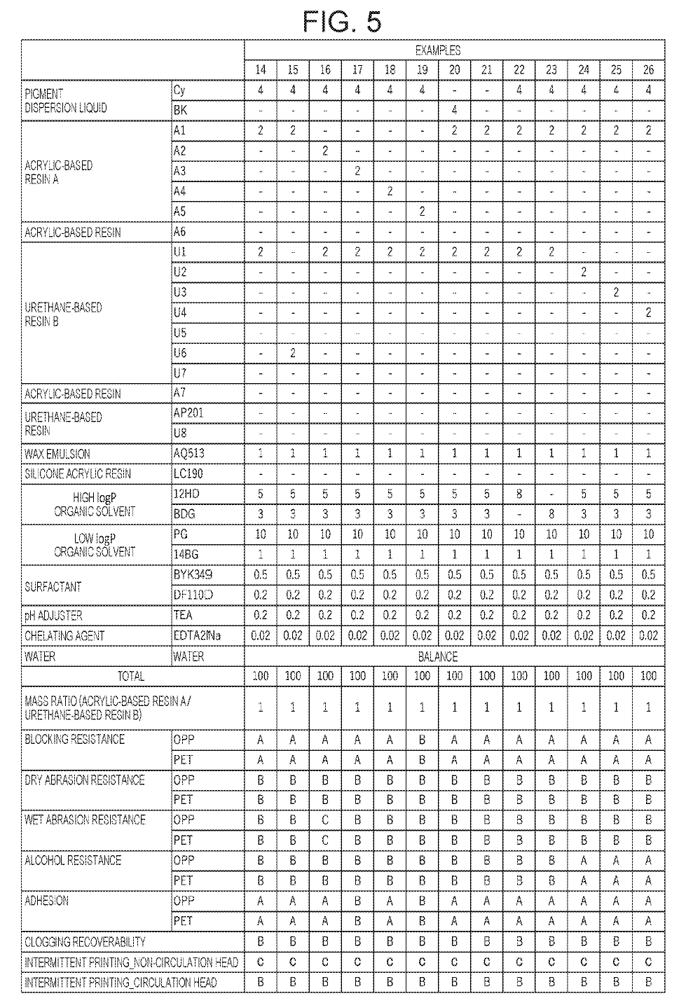

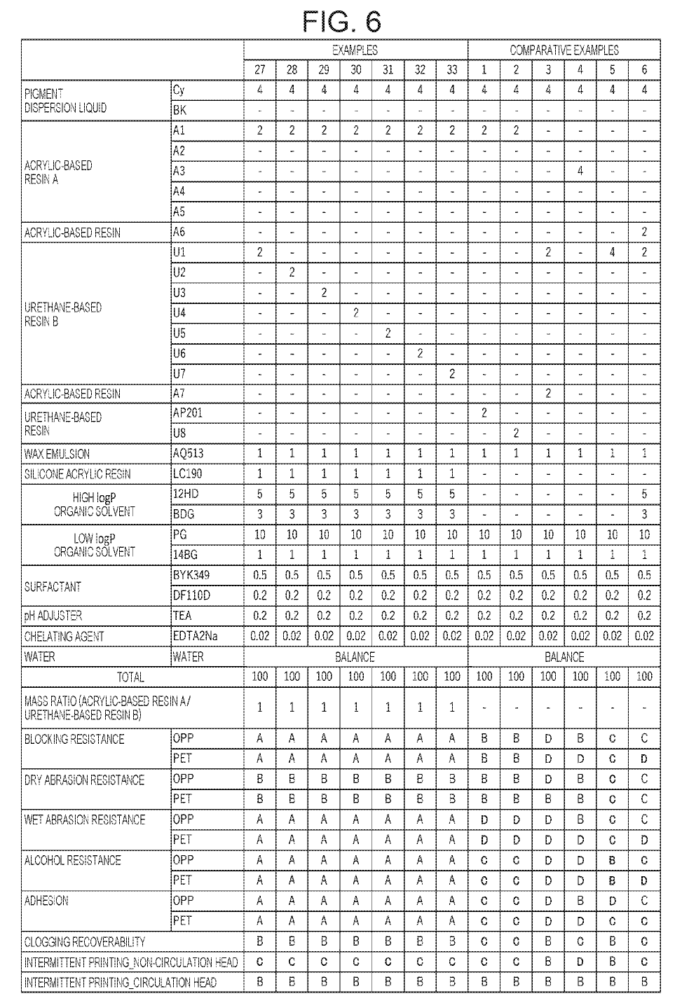

FIG. 4 to FIG. 6 show Table 3 to Table 5 showing the compositions of the respective ink compositions of Examples and Comparative Examples and the evaluation results thereof.

### 1. Preparation of Ink Jet Ink Composition

Dispersion liquids are prepared by mixing and stirring so as to have the compositions shown in Table 3 to Table 5 to obtain the ink jet ink compositions of the respective examples. In addition, in the table, each numerical value represents the mass percentage of the solid content of the component.

Details of the product components used in Table 3 to Table 5 are as follows:

### Pigment

Cy, Bk (see preparation examples below)

### Acrylic-Based Resin A

A1 to A6 (see preparation examples below)

### Urethane Resin B

U1 to U7 (see preparation examples below)

### Random Acrylic Resin

A7 (random acrylic resin, see preparation example below)

### Polyester-Based Urethane Resin

AP201(trade name "Hydran AP201," polyester-based urethane resin, manufactured by DIC Corporation)

U8 (polyester-based urethane resin, see preparation example below)

### Wax Emulsion

AQ513 (trade name "Aquacer 513," polyethylene wax emulsion, manufactured by BYK)

### Silicone Acrylic Resin

LC190 (trade name "Chaline LC190," silicone acrylic resin, manufactured by Nissin Chemical Co., Ltd.)

### Organic Solvent

12HD (1,2-hexanediol, logP_{ow} value: 0.57)

BDG (diethylene glycol monobutyl ether, logP_{ow} value: 0.56)

PG (propylene glycol, logP_{ow} value: -0.92)

14BG (1,4-butanediol, logP_{ow} value: -0.85)

### Surfactant

BYK349 (trade name, silicone-based surfactant, manufactured by BYK)

DF110D (trade name "Surfynol 104," acetylene glycol-based surfactant, manufactured by Nissin Chemical Co., Ltd.)

### pH Adjuster

TEA (triethanolamine)

### Chelating Agent

EDTA2Na (disodium dihydrogen ethylenediaminetetraacetate)

### Water

Ion exchanged water

### 1. Preparation of Pigment Dispersion Liquid

### Pigment Dispersion Liquid Bk

Carbon black in an amount of 500 g, 1,000 g of a water-soluble resin, and 14,000 g of water are mixed to obtain a mixture. As the water-soluble resin, a styrene-acrylic acid copolymer having an acid value of 100 mgKOH/g and a weight average molecular weight of 10,000 neutralized with a 0.1 mol/L aqueous sodium hydroxide solution is used. After this mixture is dispersed for 1 hour using a rocking mill using 1 mm zirconia beads, impurities are removed by centrifugation, and filtration under reduced pressure is performed using a microfilter having a pore size of 5.0 μm (manufactured by Millipore). Next, the concentration of the pigment solid content is adjusted to obtain a pigment dispersion liquid Bk having a pH of 9.0. The pigment dispersion liquid Bk contains a pigment dispersed with the water-soluble resin (a resin dispersant), and the content of the pigment is 30.0% by mass and the content of the resin is 15.0% by mass.

### Pigment Dispersion Liquid Cy

After a reaction vessel equipped with a stirrer, a thermometer, a reflux tube, and a dropping funnel is purged with nitrogen, 300 parts by mass of methyl ethyl ketone is put into the reaction vessel. Then, 40parts by mass of styrene, 40parts by mass of ethyl methacrylate, 5 parts by mass of lauryl acrylate, 5 parts by mass of lauryl methacrylate, 5 parts by mass of AM-90G (trade name, methoxypolyethylene glycol acrylate, manufactured by Shin-Nakamura Chemical Co., Ltd.), 5 parts by mass of acrylic acid, 0.2 part by mass of ammonium persulfate, and 0.3 part by mass of t-dodecyl mercaptan are put into the dropping funnel, and added dropwise into the reaction vessel over 4 hours to polymerize a polymer dispersant. Thereafter, methyl ethyl ketone is added to the reaction vessel to prepare a 40% by mass solution of the polymer dispersant.

For the polymer dispersant solution, using gel permeation chromatography (GPC) of the L7100 system manufactured by Hitachi, Ltd., its weight average molecular weight in terms of styrene is measured with tetrahydrofuran as a solvent to be 58,000. The value of the polydispersity index is 3.1.

The polymer dispersant solution in an amount of 40 parts by mass, 30 parts by mass of Chromofine Blue (trade name, C.I. Pigment Blue 15:3, manufactured by Dainichiseika Color & Chemicals Mfg. Co., Ltd.) as a cyan pigment, 100 parts by mass of 0.1 mol/L aqueous sodium hydroxide solution, and 30 parts by mass of methyl ethyl ketone are mixed, and the mixture is subjected to 8-pass dispersion treatment with Ultimizer 25005 (trade name, manufactured by Sugino Machine Limited). Thereafter, 300 parts by mass of ion exchanged water is added, and the whole amount of methyl ethyl ketone and part of water are distilled off using a rotary evaporator, and the residue is neutralized with 0.1 mol/L sodium hydroxide to adjust the pH to 9. Next, while the volume average particle size of the cyan pigment is measured with a particle size distribution analyzer, the cyan pigment is dispersed until the volume average particle size reaches 100 nm, and filtered through a 3 μm membrane filter to obtain a pigment dispersion liquid Cy with a solid content (the polymer dispersant and the pigment) of 15% by mass.

### 1.2. Preparation of Binder Resin

### 1.2.1. Preparation of Acrylic-Based Resin

### Preparation of Acrylic-Based Resin A1

A reaction vessel equipped with a stirrer, a thermometer, a reflux tube, and a nitrogen introducing tube is charged with 236.3 parts by mass of diethylene glycol monobutyl ether (BDG) and 2.3 parts by mass of 2-iodo-2-cyanopropane (CPI) as solvents, 3.7 parts by mass of 2,2-azobis(4-methoxy-2,4-dimethylvaleronitrile) (trade name "V-70," manufactured by FUJIFILM Wako Pure Chemical Corporation) as a polymerization initiator, 0.1 part by mass of N-iodosuccinimide (NIS), and 68.7 parts by mass of tetrahydrofurfuryl methacrylate (THFMA) and 68.7 parts by mass of isobornyl methacrylate (IBXMA) as monomers.

The raw materials charged into the reaction vessel are stirred while bubbling nitrogen, and polymerized at 45°C for 4 hours to synthesize a polymer (a polymer block A). The solid content measured by sampling a part of the reaction solution is 37.4%, and the polymerization conversion rate calculated based on the solid content is almost 100%. The number average molecular weight (Mn) in terms of polystyrene of the polymer block A measured by GPC with tetrahydrofuran (THF) as a developing solvent is 10,000, and the polydispersity index (PDI= weight average molecular weight (Mw)/number average molecular weight (Mn)) is 1.2. Hereinafter, the molecular weight is measured by this method. The glass transition point (Tg) of this polymer block A is calculated from the Tg of the homopolymers of the monomers and the composition ratio, and is 101.5°C. It is calculated with the Tg of the homopolymer of THFMA being 60°C and the Tg of the homopolymer of IBXMA being 155°C. Hereinafter, Tg is determined by this calculation method.

After cooling the temperature of the obtained solution of the polymer block A to 40°C, to the reaction vessel, 2.7 parts by mass of V-70 as a polymerization initiator, 18.0 parts by mass of THFMA, 54.1 parts by mass of IBXMA, and 18.0 parts by mass of methacrylic acid (MAA) as monomers are added. A polymer block B is formed by polymerization at 40°C for 4 hours to obtain an AB diblock copolymer. By measuring the solid content and measuring the amount of a residual monomer by gas chromatography, it is confirmed that the polymerization is almost completed. The solid content measured by sampling a part of the reaction solution is approximately 50%, and the polymerization conversion rate is almost 100%. The number average molecular weight (Mn) of the obtained AB diblock copolymer is 17,000, the PDI is 1.3, and the peak of GPC of the polymer block A is shifted to the high molecular weight side, and the AB diblock copolymer is confirmed. That is, the number average molecular weight (Mn) of the polymer block B is 7,000. The acid value of the polymer block B is calculated from the content of MAA in the above formulation, and is 130.3 mgKOH/g. The Tg of the polymer block B is 143.3°C. It is calculated with the Tg of the homopolymer of MAA being 228°C. A portion of the polymer solution is precipitated into methanol, filtered, washed well with methanol, and dried to obtain a resinous solid, which is titrated with an ethanolic 0.1 mol/L potassium hydroxide solution to measure the acid value to be 51.5 mgKOH/g.

Next, at room temperature, a mixed liquid of 14.0 parts by mass of 28% ammonium water and 458.6 parts by mass of ion exchanged water is added for neutralization and emulsification to obtain a self-emulsifying type acrylic-based resin A1. Hereinafter, the amount of water is adjusted to be added so as to give a polymer content of 25%. The solid content of the acrylic-based resin A1 is 25.1%. The number average particle size of emulsion particles measured using a dynamic light scattering particle size distribution analyzer (particle size measurement apparatus, trade name "nanoSAQRA," manufactured by Otsuka Electronics Co., Ltd.) after sufficiently diluting the acrylic-based resin A1 with water is 75 nm. The pH is 8.9. Furthermore, the viscosity is measured with an E-type viscosimeter to be 3.6 Pa·s at 25°C.

### Preparation of Acrylic-Based Resins A2 to A5

Self-emulsifying type acrylic-based resins A2 to A5 are obtained in the same manner as in the acrylic-based resin A1 except that the monomers to be used and the amount of ammonium water to be added for neutralization are formulated as shown in Table 1. Note that the units are all parts by mass. Table 1 summarizes the ¹⁴C concentrations of the respective monomers, and the isobornyl methacrylate contents, the biomass degrees, the number average molecular weights (Mn), the polydispersity indexes (PDIs), the acid values, the solid contents, the average particle sizes, the pHs, the viscosities, and the acid values of the respective acrylic-based resins A.

THFMA (tetrahydrofurfuryl methacrylate)

IBXMA (isobornyl methacrylate)

EMA (ethyl methacrylate)

BzMA (benzyl methacrylate)

LMA (lauryl methacrylate)

TCDMA (tricyclodecyl methacrylate)

MAA (methacrylic acid)

Preparation of Acrylic-Based Resin A6 not containing Structural Unit derived from Isobornyl (Meth)acrylate

A reaction vessel equipped with a reflux tube, a gas introducing device, a thermometer, and a stirrer is charged with 198.2 parts by mass of diethylene glycol monobutyl ether, 1.0 part by mass of iodide, 3.7 parts by mass of 2,2'-azobis(4-methoxy-2,4-dimethylvaleronitrile), 66.1 parts by mass of tricyclodecyl methacrylate, and 0.17 part by mass of diphenylmethane as a catalyst. Polymerization is carried out at 45°C for 5 hours while flowing nitrogen to obtain a solution of the polymer block A.

Next, the polymerization temperature is lowered to 40°C, and 44.0 parts by mass of tricyclodecyl methacrylate, 17.2 parts by mass of methacrylic acid, and 1.2 parts by mass of 2,2'-azobis(4-methoxy-2,4-dimethylvaleronitrile) are added to the solution of the polymer block A obtained above. Then, it is polymerized for 4 hours, and then heated to 70°C and polymerized for 1 hour to form the polymer block B, thus obtaining a solution of the AB block polymer.

After cooling the solution of the AB block polymer obtained above, 66.1 parts by mass of diethylene glycol monobutyl ether is added and dried at 150°C for 1 hour, and then a polymer with a solid content of 33.0% is obtained.

### Preparation of Random Acrylic Resin A7

A reaction vessel equipped with a stirrer, a reflux condenser, a dropping device, and a thermometer was charged with 900 g of ion exchanged water and 3 g of sodium lauryl sulfate, and the mixture was heated to 70°C while being stirred and purged with nitrogen. The internal temperature is maintained at 70°C, 4 g of potassium persulfate as a polymerization initiator was added and dissolved, and then an emulsion produced in advance by adding 20 g of acrylamide, 300 g of styrene, 640 g of butyl acrylate, and 30 g of methacrylic acid to 450 g of ion exchanged water and 3 g of sodium lauryl sulfate under stirring was continuously added dropwise to the reaction vessel over 4 hours. After the end of the dropwise addition, the mixture was aged for 3 hours. After cooling the obtained aqueous emulsion to room temperature, ion exchanged water and a 5% aqueous sodium hydroxide solution were added to adjust the solid content to 40 wt% and pH to 8.

### 1.2.2. Preparation of Urethane Resin

### Preparation of Urethane Resin U1

A reaction vessel to which a stirrer, a reflux condenser, and a thermometer are inserted was charged with 260 parts by mass of polytetramethylene glycol (PTMG2000 manufactured by Mitsubishi Chemical Corporation: number average molecular weight: 2,000), 138 parts by mass of 2,2-dimethylolpropionic acid (DMPA), and 130 parts by mass of methyl ethyl ketone (MEK, bp: 79.6°C) under a nitrogen flow, and the mixture was heated to 65°C to dissolve DMPA. Isophorone diisocyanate in an amount of 280 parts by mass and 0.26 part by mass of a urethanization catalyst XK-614 (manufactured by Kusumoto Chemicals, Ltd.) are added, and the mixture is heated to 75°C and subjected to a urethanization reaction over 5 hours to obtain an isocyanate-terminated urethane prepolymer.

Next, the reaction mixture is cooled to 70°C, 40 parts by mass of triethanolamine is added to and mixed with the reaction mixture, and 800 parts by mass of the mixture is taken out and added to a mixed liquid of 540 parts by mass of water and 40 parts by mass of triethanolamine under vigorous stirring. Next, 160 parts by mass of ice is charged, and 28 parts by mass of a 35 wt% aqueous bicycloheptanedimethanamine solution is added to conduct a chain extension reaction. Part of methyl ethyl ketone and water is distilled off so as to give a solid content concentration of 30% to obtain a urethane resin U1 (urethane resin component: 30%, water: 70%, acid value 80 mgKOH/g).

### Preparation of Urethane Resins U2 to U7

Urethane resins U2 to U7 are obtained in the same manner as in the urethane resin U1 except that isophorone diisocyanate is changed to polyisocyanates shown in Table 2.

IPDI (isophorone diisocyanate)

TDI (2,4-toluene diisocyanate)

MDI (4,4'-diphenylmethane diisocyanate)

XDI (m-xylene diisocyanate)

HDI (1,6-hexamethylene diisocyanate)

HMDI (4,4'-methylenebis(cyclohexyl isocyanate))

PDI (1,5-pentamethylene diisocyanate)

### Preparation of Urethane Resin U8

A reaction vessel to which a stirrer, a reflux condenser, and a thermometer are inserted is charged with 330 parts by mass of Polylite OD-X 2420 (molecular weight: 2,000) manufactured by DIC Corporation, 30 parts by mass of 2,2-dimethylolpropionic acid (DMPA), and 130 parts by mass of methyl ethyl ketone (MEK, bp: 79.6°C) under a nitrogen flow, and the mixture is heated to 65°C to dissolve DMPA. 2,4-Toluene diisocyanate (TDI) in an amount of 125 parts by mass and 0.26 part by mass of a urethanization catalyst XK-614 (trade name, manufactured by Kusumoto Chemicals, Ltd.) are added, and the mixture is heated to 75°C and subjected to a urethanization reaction over 5 hours to obtain an isocyanate-terminated urethane prepolymer.

Next, the reaction mixture is cooled to 70°C, 40 parts by mass of triethanolamine is added to and mixed with the reaction mixture, and 690 parts by mass of the mixture, which is almost the whole amount, is taken out and added to a mixed liquid of 540 parts by mass of water and 40 parts by mass of triethanolamine under vigorous stirring. Next, 160 parts by mass of ice is charged, and 110 parts by mass of a 35 wt% aqueous bicycloheptanedimethanamine solution is added to conduct a chain extension reaction. Part of methyl ethyl ketone and water is distilled off so as to give a solid content concentration of 30% to obtain a urethane resin U8 (urethane resin component: 30%, water: 70%, acid value 22 mgKOH/g).

### 2. Evaluation Method

### 2.1. Blocking Resistance

Using a modified machine of the printer PX-G930 (manufactured by Seiko Epson Corporation, with a modified platen heater) as a recording tester, a solid image of 1.0 inch × 0.5 inch with a recording duty of 100% is recorded on an OPP film (plain roll, 25 μm thick, manufactured by Toyobo Co., Ltd.) to obtain recorded matter. Printing is performed at a platen temperature of 60°C and a dot density of 1,440 dpi × 1,440 dpi. Using the sample, the back surface (non-corona surface) of each base material and the printed surface are bonded to each other using a blocking tester CO-201 manufactured by Tester Sangyo Co., Ltd. under the conditions of 5 kgf/cm² (50 mm φ), 50°C, and being left to stand for 24 hours (n = 3), which was visually observed and evaluated. A PET film (Taiko Polyester Film FE2001 50 μm manufactured by Futamura Chemical Co., Ltd.) is also evaluated in the same manner.

A: There is no transfer.

B: There is faint transfer.

C: There is slight transfer.

D: There is clear transfer.

### 2.2. Dry Abrasion Resistance

Using a modified machine of the printer PX-G930 (manufactured by Seiko Epson Corporation, with a modified platen heater), each ink composition is solid-printed on an OPP film at a recording duty of 100% to obtain recorded matter. The dot weight of the ink is 13 ng, the recording resolution is 720 × 720 dpi, the platen temperature is 55°C, and the post-printing drying is at 70°C for 1 minute. A PET film is evaluated in the same manner.

Evaluation is performed using a Gakushin type rubbing resistance evaluation apparatus AB-301 (trade name, manufactured by Tester Sangyo Co., Ltd.) based on JIS L0849 2013. One day after the printing, the 1.0 inch × 0.5 inch recorded matter is rubbed with dry shirting under the condition of 100 round-trips with a load of 200 g. Thereafter, stains on the shirting, stains on the peripheral portion of the recorded portion, and the degree of peeling in the printed portion are visually observed, and the dry abrasion resistance is evaluated in accordance with the following evaluation criteria. A PET film is evaluated in the same manner.

### Evaluation Criteria

A: There are no stains on the shirting and there are no stains on the peripheral portion of the recorded portion, and there is no peeling in the recorded portion.

B: There are almost no stains on the shirting and there are almost no stains on the peripheral portion of the recorded portion, and there is almost no peeling in the recorded portion.

C: There are few stains on the shirting and there are few stains on the peripheral portion of the recorded portion, and there is almost no peeling in the recorded portion.

D: There are stains on the shirting and there are stains on the peripheral portion of the recorded portion, and there is peeling in the recorded portion.

### 2.3. Wet Abrasion Resistance

The wet abrasion resistance is evaluated in the same manner as in the test of the dry abrasion resistance except that the sample is rubbed with shirting moistened with water under the condition of 15 round-trips with a load of 250 g instead of the condition of 100 round-trips with a load of 200 g with the dry shirting. The wet abrasion resistance is evaluated in accordance with the following evaluation criteria. A PET film is evaluated in the same manner.

### Evaluation Criteria

A: There are no stains on the shirting and there are no stains on the peripheral portion of the recorded portion, and there is no peeling in the recorded portion.

B: There are almost no stains on the shirting and there are almost no stains on the peripheral portion of the recorded portion, and there is almost no peeling in the recorded portion.

C: There are few stains on the shirting and there are few stains on the peripheral portion of the recorded portion, and there is almost no peeling in the recorded portion.

D: There are stains on the shirting and there are stains on the peripheral portion of the recorded portion, and there is peeling in the recorded portion.

### 2.4. Ethanol Resistance

The ethanol resistance is evaluated in the same manner as in the test of the wet abrasion resistance except that shirting moistened with ethanol is used instead of the shirting moistened with water. The ethanol resistance is evaluated in accordance with the following evaluation criteria. A PET film is evaluated in the same manner.

### Evaluation Criteria

A: There are no stains on the shirting and there are no stains on the peripheral portion of the recorded portion, and there is no peeling in the recorded portion.

B: There are almost no stains on the shirting and there are almost no stains on the peripheral portion of the recorded portion, and there is almost no peeling in the recorded portion.

C: There are few stains on the shirting and there are few stains on the peripheral portion of the recorded portion, and there is almost no peeling in the recorded portion.

D: There are stains on the shirting and there are stains on the peripheral portion of the recorded portion, and there is peeling in the recorded portion.

### 2.5. Adhesion Evaluation

Using the same recording tester, the ink composition is printed on a corona-treated OPP film (trade name "FOS-AQ#60", manufactured by Futamura Chemical Co., Ltd.) at 100% duty under the conditions of a dot weight of 13 ng, a recording resolution of 720 × 720 dpi, and a platen temperature of 55°C, and dried at 90°C for 10 minutes to prepare recorded matter. The remaining state of the ink in the recorded portion and the transfer state to tape when a crosscut test conforming to JIS-K5600 is performed are observed, and the adhesion is evaluated based on the following evaluation criteria. A PET film is evaluated in the same manner.

### Evaluation Criteria

A: There is no peeling in the film recorded portion, and there is no transfer to the tape, either.

B: Peeling in the film recorded portion is within 5%.

C: Peeling in the film recorded portion is more than 5% and 10% or less.

D: Peeling in the film recorded portion is more than 10%.

### 2.6. Clogging Recoverability Test

Using the same recording tester, the clogging recoverability is evaluated in an environment at a temperature of 40°C and a relative humidity of 20%. First, it is confirmed that the ink jet ink composition is normally ejected from all nozzles. Then, the recording tester is left to stand in an environment at a temperature of 40°C and a relative humidity of 20% for 1 month. After being left to stand, the number of times of cleaning required for normal ejection from all the nozzles is measured, and the clogging recoverability is evaluated based on the following evaluation criteria.

### Evaluation Criteria

A: The number of times of cleaning is 3 or less.

B: The number of times of cleaning is 4 to 6.

C: The number of times of cleaning is 7 to 9.

D: Even when the number of times of cleaning is 10, not all the nozzles are recovered.

### 2.7. Intermittent Printing Stability

Using the same recording tester, the intermittent printing stability during intermittent printing is evaluated in an environment at a temperature of 40°C and a relative humidity of 20%. First, it is confirmed that the ink composition is normally ejected from all nozzles. Then, after the ink composition is ejected onto an A4 size OHP film, a resting time of 2 minutes is provided in an environment at a temperature of 40°C and a relative humidity of 20%, and the ink composition is ejected again onto A4 size photo paper. In the second ejection, the dot positional deviation between the position of the dot of the first droplet attached onto the A4 size photo paper and the target position is measured with an optical microscope. Based on the obtained dot positional deviation, the intermittent printing stability is evaluated based on the following evaluation criteria.

In the non-circulation, a resting time of 2 minutes is provided without circulating the ink in the head. In the circulation, a head capable of circulating the ink is used, and a head modified to include a circulation mechanism for discharging the ink from an ink passage between a pressure chamber and a nozzle to the outside of the head, mixing the discharged ink with new ink, and supplying the mixed ink to the head again is used, and a resting time of 2 minutes is provided while circulating the ink.

### Evaluation Criteria

AA: The dot positional deviation is 5 μm or less.

A: The dot positional deviation is more than 5 μm and 10 μm or less.

B: The dot positional deviation is more than 10 μm and 20 μm or less.

C: The dot positional deviation is more than 20 μm and 30 μm or less.

D: The dot positional deviation exceeds 30 μm.

### 3. Evaluation Results

From Tables 3 to 5, the ink jet ink composition of the present embodiment tends to further improve in the dry abrasion resistance, the wet abrasion resistance, and the adhesion. In addition, it tends to further improve also in the blocking resistance, the ethanol resistance, the clogging recoverability, and the intermittent printing stability.

What is claimed is:

1. A water-based ink jet ink composition comprising a binder resin, wherein the binder resin contains an acrylic-based resin that is a block copolymer containing a structural unit derived from isobornyl (meth)acrylate, and a polyether-based urethane resin.

2. The ink jet ink composition according to claim 1, wherein a content of the structural unit derived from isobornyl (meth)acrylate is 50% by mass or more with respect to a total amount of the acrylic-based resin.

3. The ink jet ink composition according to claim 1, wherein the block copolymer contains an A block and a B block that is more hydrophilic than the A block.

4. The ink jet ink composition according to claim 1, wherein an acid value of the acrylic-based resin is 25 to 100 mgKOH/g.

5. The ink jet ink composition according to claim 1, wherein
the acrylic-based resin contains a structural unit derived from an acrylic-based monomer, and
a content of the structural unit derived from an acrylic-based monomer is 90% by mass or more with respect to a total amount of the acrylic-based resin.

6. The ink jet ink composition according to claim 1, wherein the polyether-based urethane resin contains a polyether-based urethane resin having an aromatic ring skeleton and/or an alicyclic skeleton.

7. The ink jet ink composition according to claim 1, wherein a mass ratio of the polyether-based urethane resin to the acrylic-based resin is 1/3 to 3.

8. The ink jet ink composition according to claim 1, comprising an organic solvent, wherein the organic solvent contains an organic solvent A having an octanol-water partition coefficient of 0 to 1.

9. The ink jet ink composition according to claim 1, comprising a pigment.

10. The ink jet ink composition according to claim 1, further comprising a wax emulsion.

11. The ink jet ink composition according to claim 1, further comprising a silicone acrylic resin.

12. A recording method comprising an ink attaching step of ejecting the ink jet ink composition according to claim 1 from an ink jet head to attach the ink jet ink composition to a recording medium.
